(19) United States
(12) Patent Application Publication
(10) Pub. No.: US 2008/0056072 A1
(43) Pub. Date: Mar. 6, 2008

(54) DAYLIGHT SAVING TIME ADJUSTMENT METHOD AND TIMEPIECE EMPLOYING THE METHOD

(75) Inventor: Chih-Yuh Chen, Taipei City (TW)

Correspondence Address: DUTECK INDUSTRIAL CO., LTD., P.O. BOX 108-00403, TAIPEI (R.O.C.), TW

(73) Assignee: DUTECK INDUSTRIAL CO., LTD., Taipei City (TW)

(21) Appl. No.: 11/936,802

(22) Filed: Nov. 8, 2007

Related U.S. Application Data
(63) Continuation-in-part of application No. 11/428,565, filed on Jul. 4, 2006.

(51) Int. Cl. G04C 11/00; G04C 11/08

(52) U.S. Cl. 368/46

(57) ABSTRACT

Used in an analog timepiece, a daylight saving time adjustment method is disclosed to includes the steps of: (a) use a time setting device to input date and time data and an adjustment knob to the adjust the hour and minute hands to 12:00, (b) use setting and selection buttons of the time setting device to adjust polarity relationship between stator and rotor of a driving unit for the rotor to move a gearwheel set and to further adjust the second hand to 12:00, (c) the CPU of the analog timepiece analyzes the inputted data subject to calculation of its built-in daylight saving time calculation program, and then drives the driving unit to move the hour and minute hands to indicate the local standard time subject to the inputted data if the inputted data was inputted before start of daylight saving time, or to indicate the corrected local daylight saving time if the inputted data was inputted after start of daylight saving time, and (d) CPU drives the driving unit to move the hands set, returning the analog timepiece from the daylight saving time to the standard time.

This application is a Continuation-In-Part of my patent application Ser. No. 11/428,565, filed on Jul. 4, 2006.

### BACKGROUND OF THE INVENTION

1. Field of the Invention

The present invention relates to a daylight saving time adjustment method employed in an analog timepiece for adjusting the analog timepiece to enter or withdraw from daylight saving time by using the time setting device of the analog timepiece to input date and time data and then using an adjusting knob of the time setting device to adjust the hour hand and minute hand and then using a button set of the time setting device to adjust the polarity relationship between rotor and stator of a driving unit for enabling the hour hand, minute hand and second hand to be moved subject to the standard time or daylight saving time.

2. Description of the Related Art

There are more than 70 countries around the world that employ daylight saving time. However, different countries in different time zone may start daylight saving time at a different date for a different period. When traveling from one time zone to a destination at another time zone, one shall have to check the local rule of daylight saving time and then to adjust the timepiece subject to the local rule. When departing from the destination, one shall have to adjust the timepiece, returning to the standard time. When returning the timepiece from the daylight saving time employed at a particular time zone to the standard time at one's mother country, the added time correction value must be deducted. This daylight saving time adjustment procedure is complicated.

There are electronic timepieces that automatically adjust daylight saving time. However, the user must carefully watch the display during adjustment, avoiding confusion between morning and afternoon times (for example, 7:00 AM and 7:00 PM). A mistake may occur if the user does not carefully check the time indicated to be a morning time or afternoon time when adjusting the timepiece after starting time of daylight saving time.

Therefore, it is desirable to provide a daylight saving time adjustment method and analog timepiece using the method that eliminates the aforesaid problems.

### SUMMARY OF THE INVENTION

The present invention has been accomplished under the circumstances in view. The daylight saving time adjustment method is used in an analog timepiece that comprises a movement, which comprises a CPU (central processing unit), a time setting device, a time display device and a driving unit. The CPU has built therein a time zone calculation program and a daylight saving time calculation program. The time setting device comprises an adjustment knob, a gearwheel set and a button set. The button set comprises a setting button and a plurality of selection buttons. The time display device comprises a hands set, which includes an hour hand, a minute hand and a second hand. The driving unit comprises a rotor and a stator. The daylight saving time adjustment method comprises the steps of: (a) input year, month, date, hour, minute and second data by means of the time setting device and operating the adjustment knob of the time setting device to the adjust hour hand and minute hand of the hands set to 12:00 position; (b) the CPU controls polarity of the rotor and the stator of the driving unit to match with the operation of the setting button and selection buttons of the button set of the time setting device in driving the gearwheel set to adjust the second hand of the hands set to 12:00 position; (c) the CPU analyzes the inputted data subject to calculation of the calendar program and compares the inputted data to starting time and ending time of daylight saving time set therein, and then proceeds to step (d) if the inputted data was inputted before start of daylight saving time, or step (f) if the inputted data was inputted after start of daylight saving time; (d) the CPU drives the driving unit to rotate the gearwheel set of the time setting device and to further move the hour hand and the minute hand subject to the inputted hour and minute data; (e) Upon start of daylight saving time, the CPU drives the driving unit to turn the gearwheel set of the time setting device to move the hour hand and the minute hand ahead subject to a predetermined time correction value for daylight saving time; (f) the CPU drives the driving unit to turn the gearwheel set of the time setting device, adjusting the hour hand and minute hand from a standard time to a daylight saving time; and (g) the CPU drives the driving unit to move the gearwheel set and then the hands set, deducing the added time correction value and returning the analog timepiece from the daylight saving time to the standard time.

### BRIEF DESCRIPTION OF THE DRAWINGS

FIG. 1 is an oblique back elevation of the present invention.

FIG. 2 is an oblique front elevation of the present invention.

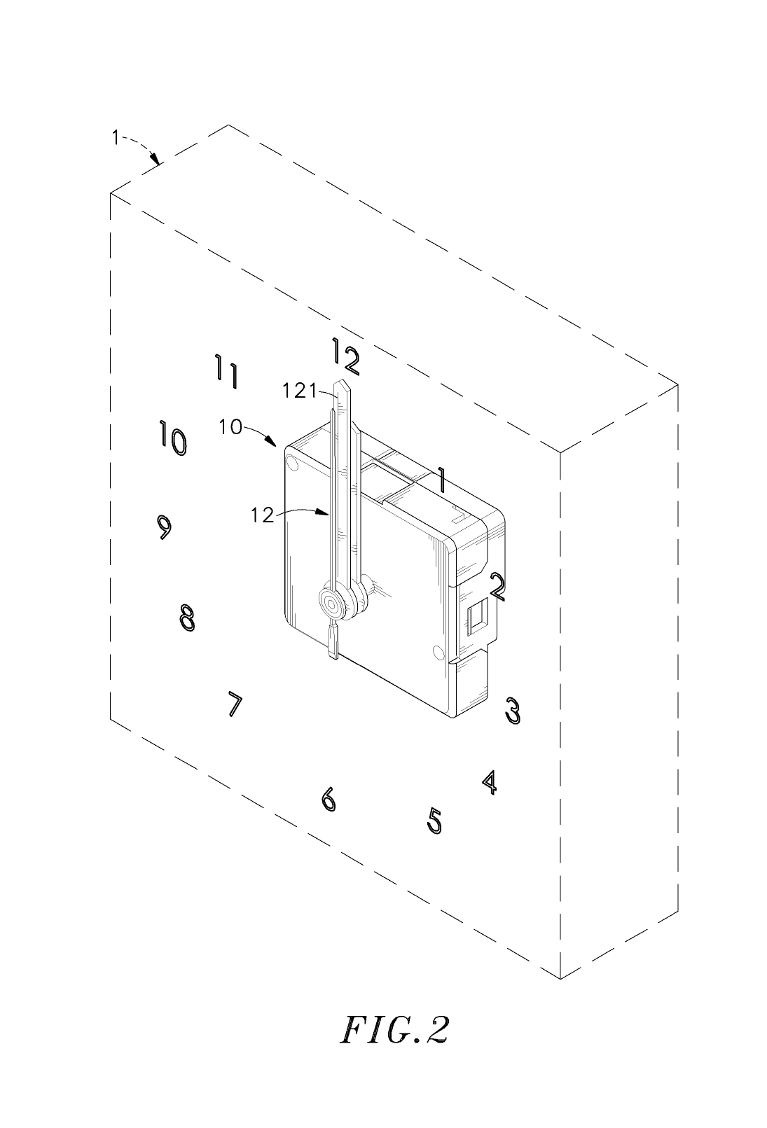

FIG. 3 is a block diagram of the present invention.

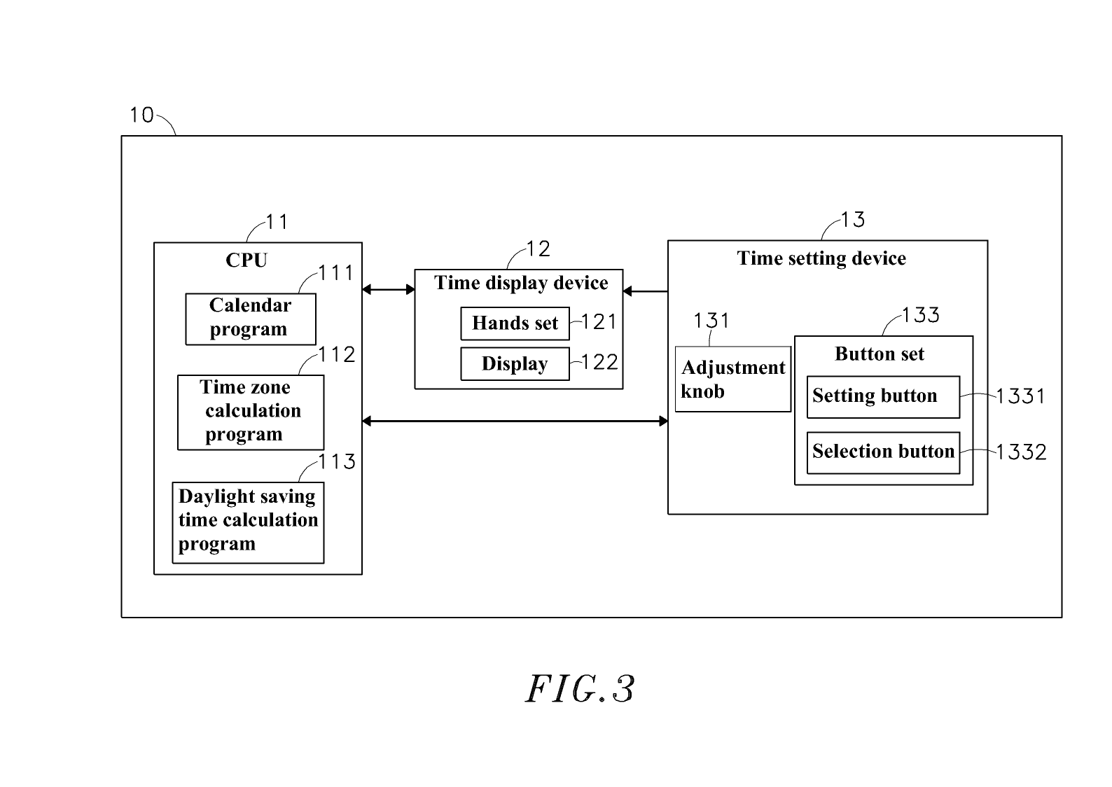

FIG. 4 is an exploded view of the movement of the present invention.

FIG. 5 is a flowchart of the present invention.

### DETAILED DESCRIPTION OF THE PREFERRED EMBODIMENT

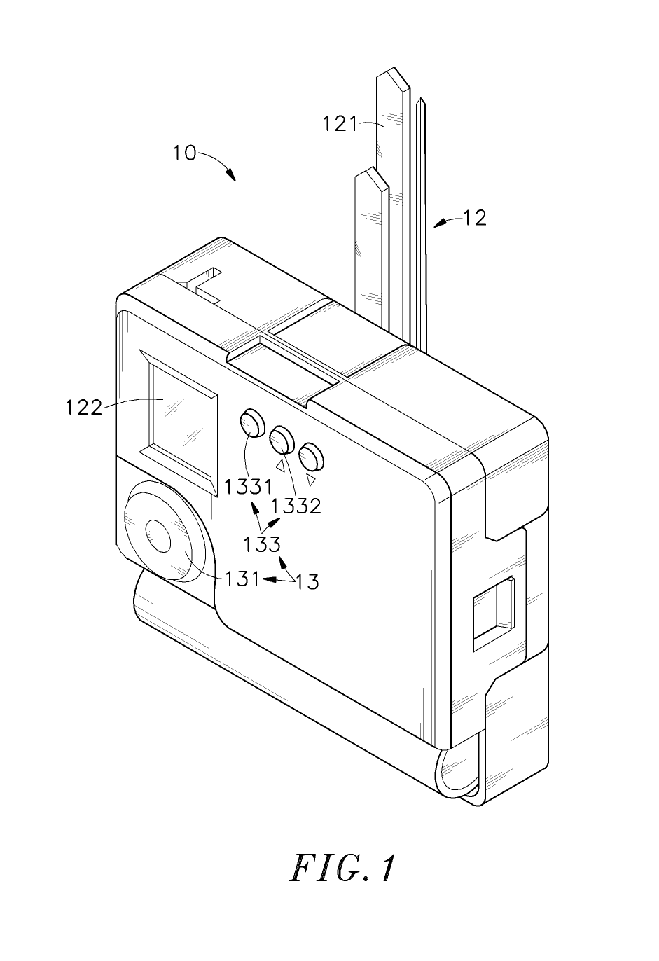

Referring to FIGS. 1˜4, an analog timepiece 1 is shown comprising a movement 10 on the inside. The movement 10 comprises a CPU (central processing unit) 11, a time display device 12, a time setting device 13, and a driving unit 14.

The CPU 11 is the arithmetic logic unit of the movement 10 for controlling the display 122 of the time display device 12 to display the set time and date, having built therein a calendar program 111, a time zone calculation program 112, and a DST (daylight saving time) calculation program 113. The calendar program 111 has the function of calculating solar year, leap year, lunar year and leap month. When zeroed the reading, the CPU 11 matches the set current time and date with the calendar program 111, driving the display 122 to display the accurate time and date. The time zone calculation program 112 calculates the time for each time zone subject to the setting of the time setting device 13. The DST (daylight saving time) calculation program 113 has set therein the daylight saving time rules issued by different countries at different time zones.

The time display device 12 adjusts the indication of the hour hand, minute hand and second hand of the hands set 121 thereof subject to the signal produced by the time setting device 13 and transmitted from the CPU 11.

The time setting device 13 can be disposed on the outside of the movement 10. Alternatively, the time setting device 13 can be disposed on the inside of the movement 10. The time setting device 13 comprises an adjustment knob 131, a gearwheel set 132, and a button set 133. The button set 133 comprises a setting button 1331 and two selection buttons 1332. The adjustment knob 131 is rotatable to drive the gearwheel set 132, causing the gearwheel set 132 to move the hour hand, minute hand and second hand of the hands set 121. By means of the setting button 1331 and selection buttons 1332 of the button set 133, the user can input date and time, setting the date and the time. After input of date and time, the time zone calculation program 112 of the CPU 11 calculates the time for each time zone to match with the setting of daylight saving time.

The driving unit 14 comprises a stator 141 and a rotor 142, is adapted to drive the gearwheel set 132, causing the gearwheel set 132 to move the hour hand, minute hand and second hand of the hands set 121 subject to the setting.

By means of the adjustment knob 131, the hour hand, minute hand and second hand of the hands set 121 of the time display device 12 of the analog timepiece 1 are adjusted to the zero point (the 12:00 position on the dial), and then the setting button 1331 and selection buttons 1332 (left button: UP; right button: DOWN) of the button set 133 of the time setting device 13 are operated to move the rotor 142 of the driving unit 14 relative to the stator 141 subject to the magnetic repulsive force produced because of same polarity (N pole or S pole) between the rotor 142 and the stator 141, causing the gearwheel set 132 to adjust the second hand to the zero point position, and therefore the hour hand, the minute hand and the second hand are all adjusted to the zero point position. At this time, the CPU 11 receives the message that the hour hand, second hand and minute hand of the hands set 121 are at the start position, and the DST (daylight saving time) calculation program 113 of the CPU 11 start calculation where the signal of the date and time data inputted through the time setting device 13 is deducted by the adjustment time of daylight saving time, and then the CPU 11 drives the driving unit 14 to move the gearwheel set 132 fast forward (for example, 11 hours forwards, i.e., 1 hour backwards). By means of fast forward adjustment to adjust the number of hours subject to the applied DST (daylight saving time) system, the hands set 121 of the time display device 12 of the analog timepiece 1 is adjusted to indicate the standard time.

The invention uses the built-in driving unit 14 (synchronizing motor) to move the gearwheel set 132 and to further adjust movement of the hour hand, minute hand and second hand of the hands set 121, thereby indicating the correct time. When the CPU 11 outputs a setting signal (the polarity of the rotor 142) to the time display device 12, the gearwheel set 132 of the driving unit 14 is driven to move the hour hand and minute hand of the hands set 121 rapidly to indicate the correct time.

Referring to FIGS. 1˜4 again, the time display device 12 of the movement 10 is disposed at the front side of the analog timepiece 1, the setting button 1331 and selection buttons 1332 of the button set 133 extend out of the back side of the movement 10, and the hands set 121 of the time display device 12 of the movement 10 is disposed at the center of the front side of the analog timepiece 1. Thus, the user can press the setting button 1331 and selection buttons 1332 of the button set 133 to input the adjusted time signal into the CPU 11 for calculation by the time zone calculation program 112, preventing an error.

Further, when the power of the analog timepiece 1 is turned on (after loading of the battery or connection of the external power source), the start position adjusting operation can then be started by: rotating the adjustment knob 131 of the time setting device 13 to turn the gearwheel set 132, moving the hour hand and minute hand of the hands set 121 to the start position (12:00 position on the dial of the analog timepiece). After setting of the start position, press the setting button 1331. If the analog timepiece 1 is used in a country that does not employ the DST (daylight saving time) system, operate the selection buttons 1332 to shift DST/ON to DST/OFF.

Thereafter, the user can start time setting, i.e., operate the selection buttons 1332 to set hour, minute and second subject to the applied DST system and then press the setting button 1331 to input the setting into the CPU 11 for matching by the built-in calendar program 111 for accurate indication of time. After setting, the analog timepiece 1 indicates the current local time accurately, and no further adjustment of the date upon a big month or small month or adjustment of the month and date upon a leap year will be necessary.

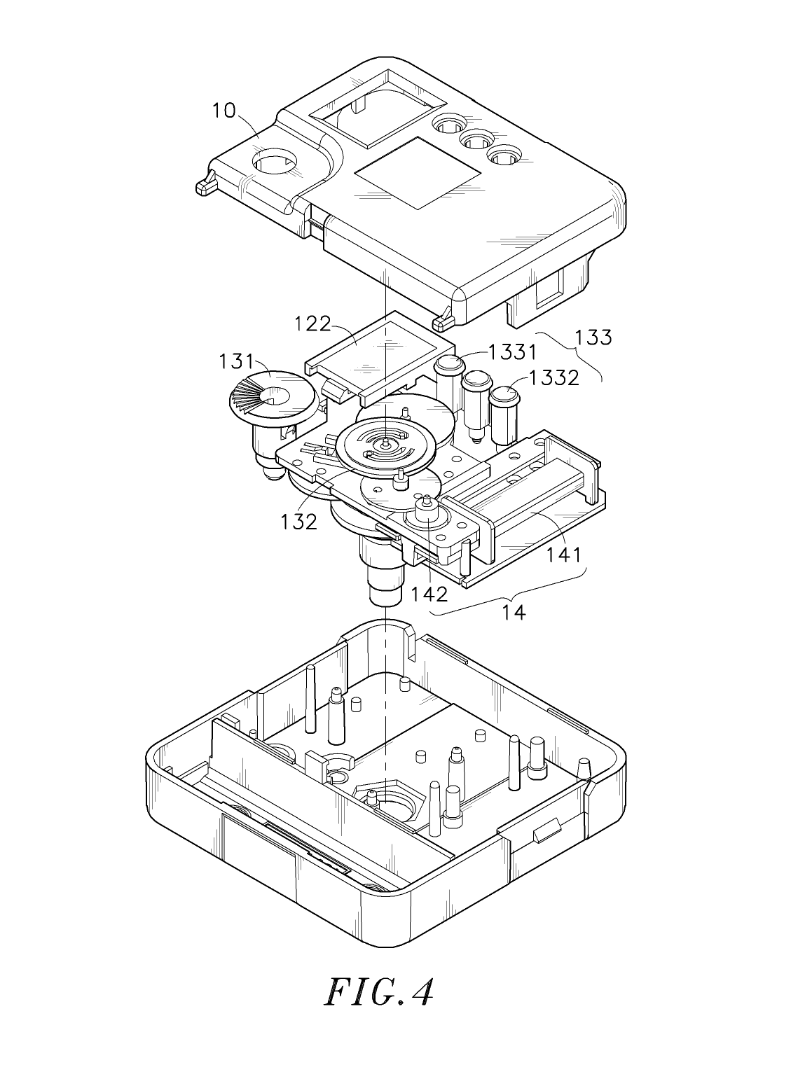

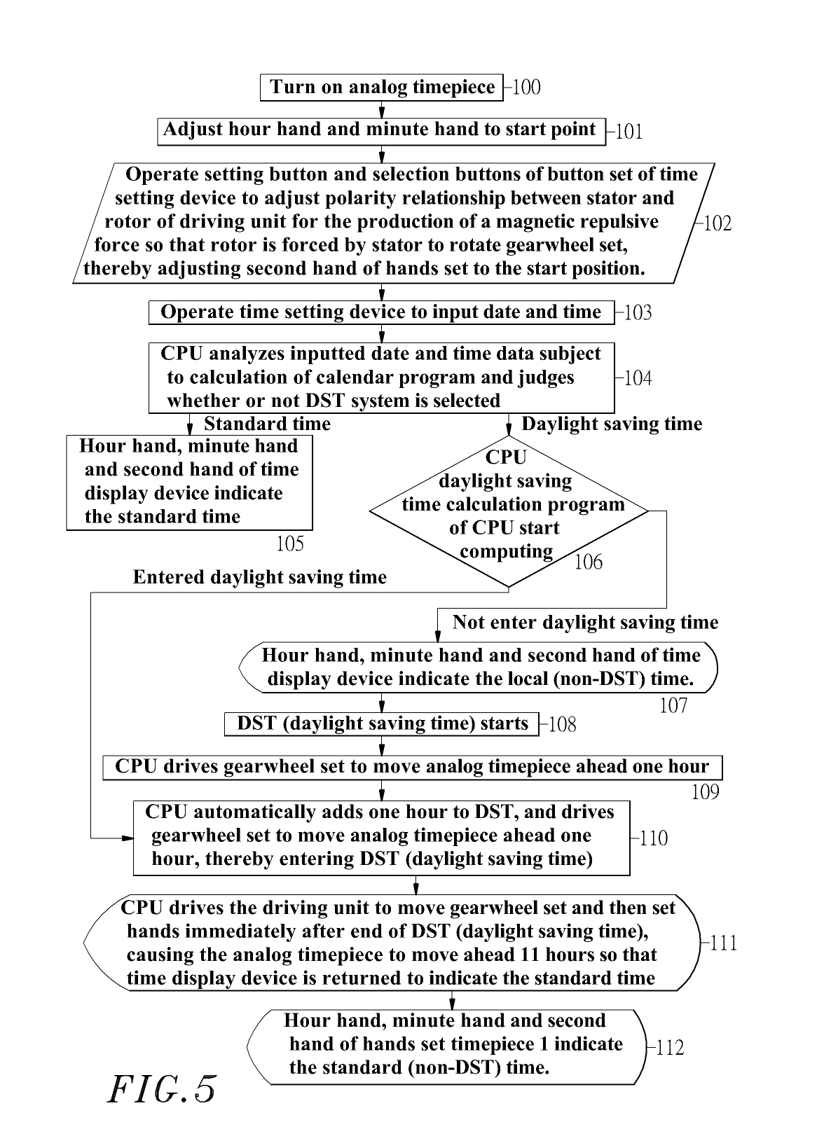

Referring to FIG. 5 and FIG. 4 again, after the user zeroed the readings of the analog timepiece 1 and finished the adjustment of the time and time zone, the DST (daylight saving time) calculation program 113 judges whether or not the current time zone employs the DST system, and then runs subject to the following steps:
100 Turn on the power of the analog timepiece 1 (loading the battery in the analog timepiece 1 or electrically connect the analog timepiece 1 to an external power source).
101 Operate the adjustment knob 131 of the time setting device 13 of the analog timepiece 1 to adjust the hour hand and minute hand of the hands set 121 of the time display device 12 to the start position (12:00 position).
102 Operate the setting button 1331 and selection buttons 1332 of the button set 133 of the time setting device 13 to adjust the polarity relationship between the stator 141 and rotor 142 of the driving unit 14 for the production of a magnetic repulsive force so that the rotor 142 is forced by the stator 141 to rotate the gearwheel set 132, thereby adjusting the second hand of the hands set 121 to the start position.
103 Operate the time setting device 13 of the analog timepiece 1 to input date and time.
104 The CPU 11 analyzes the inputted date and time data subject to the calculation of the calendar program 111 and judges whether or not DST system is selected, and then proceeds to step (105) in case of the standard time (when DST system is not selected) or step (106) when in case of the daylight saving time (the DST system is employed).
105 The hour hand, minute hand and second hand of the hands set 121 of the time display device 12 indicate the standard time.
106 The CPU 11 of the analog timepiece 1 gives an indication message after computing through its built-in DST (daylight saving time) calculation program 113, and then proceeds to step (107) when DST (daylight saving time) is employed or step (110) when DST (daylight saving time) is not employed.
107 The hour hand, minute hand and second hand of the time display device 12 of the analog timepiece 1 indicate the local (non-DST) time.
108 DST (daylight saving time) starts.
109 The CPU 11 of the analog timepiece 1 drives the gearwheel set 132 to move the hour hand and minute hand of the hands set 121 when DST is started, changing the analog timepiece ahead one hour.
110 The CPU 11 automatically adds one hour to DST (daylight saving time), and drives the gearwheel set 132 to move the (hour hand and minute hand) of the hands set 121 ahead one hour, thereby entering DST (daylight saving time).
111 Immediately after the end of DST (daylight saving time), the CPU 11 of the analog timepiece 1 drives the driving unit 14 to move the hands set 121 via the gearwheel set 132, causing the analog timepiece 1 to move ahead 11 hours and the time display device 12 to be returned to the position before adjustment of DST (daylight saving time).
112 The hour hand, minute hand and second hand of the hands set 121 of the time display device 12 of the analog timepiece 1 indicate the standard (non-DST) time.

Therefore, immediately after the user zeroed the reading, set the time and adjusted the time zone, the DST (daylight saving time) calculation program 113 starts computing to adjust the local DST (daylight saving time). For example, in the United States, DST (daylight saving time) currently starts on the second Sunday of March and ends on the first Sunday of November, with all time changes taking place at 2:00 a.m. local time. From 1986 through 2006, DST (daylight saving time) began on the first Sunday of April and ended on the last Sunday of October. The schedule for 2006 in the United States was that DST began on the first Sunday in Apr. 2, 2006, and changed back to standard time on the last Sunday in Oct. 29, 2006. The time is adjusted at 2 AM local time. When the set time is not within the DST (daylight saving time) application period, it keeps steps (101), (102), (103), (104) and (105), and will start step (106) to start calculation of local daylight saving time only when the local time zone enters DST (daylight saving time). Therefore, the CPU 11 calculates the corresponding time subject to the time zone signal and applicability of DST (daylight saving time) inputted through the button set 133, and then drives the driving unit 14 to move the gearwheel set 132, adjusting the indication of the hour hand, minute hand and second hand of the hands set 121 of the time display device 12.

Further, if the date and time data inputted through the time setting device 13 does not include DST (daylight saving time), the CPU 11 directly drives the time zone calculation program 112 to calculate the standard time.

Therefore, the daylight saving time adjustment method and timepiece employing the method of the present invention has the following advantages and features:

When the timepiece is in use, it needs only one single setting, and the CPU 11 will drives the driving unit 14 to move the gearwheel set 132 subject to the setting, causing the time display device 12 to indicate the corresponding time. Further, the user can operated the adjustment knob 131 of the time setting device 13 to zero the indication of the hour hand and minute hand of the hands set 121, and then operated the setting button 1331 and selection buttons 1332 of the button set 133 to zero the indication of the second hand of the hands set 121. Thereafter, the CPU 11 controls entering or withdrawing from DST (daylight saving time). After the end of DST (daylight saving time), the CPU 11 drives the rotor 142 of the driving unit 14 to move the hands set 121 via the gearwheel set 132, causing the hour and minute hand of the hands set 121 to move ahead 11 hours or turned back 1 hour, and therefore the time display device 12 is returned to the standard time.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A daylight saving time adjustment method used in an analog timepiece comprising a movement, said movement comprising a CPU (central processing unit), a time setting device, a time display device and a driving unit, said CPU having built therein a time zone calculation program and a daylight saving time calculation program, said time setting device comprising an adjustment knob, a gearwheel set and a button set, said button set comprising a setting button and a plurality of selection buttons, said time display device comprising a hands set, said hands set comprising an hour hand, a minute hand and a second hand, said driving unit comprising a rotor and a stator, the daylight saving time adjustment method comprising the steps of:
(a) input year, month, date, hour, minute and second data by means of said time setting device and operating the adjustment knob of said time setting device to the adjust hour hand and minute hand of said hands set to 12:00 position;
(b) said CPU controls polarity of said rotor and said stator of said driving unit to match with the operation of the setting button and selection buttons of the button set of said time setting device in driving said gearwheel set to adjust the second hand of said hands set to 12:00 position;
(c) said CPU analyzes the inputted data subject to calculation of said calendar program and compares the inputted data to starting time and ending time of daylight saving time set therein, and then proceeds to step (D) if the inputted data was inputted before start of daylight saving time, or step (F) if the inputted data was inputted after start of daylight saving time;
(d) said CPU drives said driving unit to rotate said gearwheel set of said time setting device and to further move said hour hand and said minute hand subject to the inputted hour and minute data;
(e) Upon start of daylight saving time, said CPU drives said driving unit to turn said gearwheel set of said time setting device to move said hour hand and said minute hand ahead subject to a predetermined time correction value for daylight saving time;
(f) said CPU drives said driving unit to turn said gearwheel set of said time setting device, adjusting the hour hand and minute hand from a standard time to a daylight saving time;
(g) said CPU drives said driving unit to move said gearwheel set and then said hands set, deducing the added time correction value and returning the analog timepiece from the daylight saving time to the standard time.

2. The daylight saving time adjustment method as claimed in claim 1, wherein said daylight saving time calculation program of said CPU has set therein application dates of daylight saving time in different countries.

3. The daylight saving time adjustment method as claimed in claim 1, wherein said CPU further has built therein a calendar program, said calendar program having the function of calculating solar year, leap year, lunar year and leap month; when the user reset the analog timepiece, said CPU matches the set current time and date with said calendar program to indicate the accurate time and date.

4. The daylight saving time adjustment method as claimed in claim 1, wherein said CPU controls polarity of said rotor and said stator of said driving unit to cause magnetic repulsion between said rotor and said stator for enabling said rotor to move said gearwheel set in turning said second hand of said hands set.
